(19) United States
(12) Patent Application Publication
(10) Pub. No.: US 2017/0332627 A1
(43) Pub. Date: Nov. 23, 2017

(54) AGROCHEMICAL RESINATES FOR AGRICULTURAL APPLICATIONS

(71) Applicant: CROP ENHANCEMENT, INC., Cambridge, MA (US)

(72) Inventors: K. Suzanne Rawden, Somerville, MA (US); Sandra Rifai, Somerville, MA (US); Gangadhar Jogikalmath, Cambridge, MA (US); Andrea Schneider, Hyde Park, MA (US); Jonathan Flores, Hyde Park, MA (US); David S. Soane, Palm Beach, FL (US)

(21) Appl. No.: 15/474,090

(22) Filed: Mar. 30, 2017

Related U.S. Application Data
(63) Continuation of application No. PCT/US2015/053352, filed on Sep. 30, 2015.
(60) Provisional application No. 62/058,383, filed on Oct. 1, 2014.

(51) Int. Cl. A01N 25/22; A01N 25/10; A01N 25/26; B01J 45/00

(52) U.S. Cl. CPC A01N 25/22; B01J 45/00; A01N 25/10; A01N 25/26

(57) ABSTRACT

The invention encompasses resinate formulations comprising an agricultural active ingredient and an ion exchange resin, wherein the agricultural active ingredient is imbibed upon the ion exchange resin; and methods of treating an agricultural surface. The invention also encompasses methods of manufacturing an agricultural formulation comprising a resinate, comprising: providing an agricultural active ingredient and an ion exchange resin; and mixing the agricultural active ingredient and the ion exchange resin to imbibe the agricultural active ingredient upon the ion exchange resin, thereby forming the resinate.

### RELATED APPLICATIONS

This application is a continuation of International Application No. PCT/US2015/053352, which designated the United States and was filed on Sep. 30, 2015, published in English, which claims the benefit of U.S. Provisional Application Ser. No. 62/058,383 filed Oct. 1, 2014. The entire contents of the above applications are incorporated by reference herein.

### FIELD OF THE APPLICATION

This application relates to formulations and methods for delivering agricultural active ingredients.

### BACKGROUND

Pesticides are widely used in agriculture for plant protection purposes. However, in addition to eliminating undesirable weeds, disease or insects, many pesticides have secondary environmental effects due to their toxicity towards nontarget plants and organisms, high volatility, water solubility, and droplet drift during spray application. Very little of the active ingredient (AI) (i.e., the substance in a formulation responsible for the performance objectives thereof) actually reaches the target site of crops as a result of leaching, surface runoff, degradation by photolysis, hydrolysis and microbial degradation. Consequently, multiple pesticide applications are often necessary, which leads to unfavorable environmental impacts. Thus, the development of formulations increasing the efficacy and safety of these agrochemicals has taken precedence.

The use of controlled release formulations of pesticides has been actively explored to overcome the aforementioned effects of AI losses. Such systems are designed to improve the AI release kinetics and enhance targeted activity in a more eco-friendly application process. Similar problems affect other agricultural active ingredients such as herbicides and fungicides that are used to treat agricultural surfaces, for example soil surfaces or plant surfaces. Pesticides and other AIs typically require formulation before use. Formulations can be produced to fulfill various objectives, for example, having a high target activity throughout the time required, or minimizing adverse environmental effects, or promoting safer handling, or allowing ease of compatibility with application equipment.

Commercialized AIs for agricultural use, which may include herbicides, insecticides, fungicides, biologics, fertilizers, plant hormones, plant growth regulators, and the like, often are formulated to include a controlled release mechanism. As used herein, the term “agricultural active ingredient” or “AAI” refers to an active ingredient such as a herbicide, an insecticide, a fungicide, a fertilizer, a biologic, a plant hormone, a plant growth regulator, or any other agent, where such agent is applicable to a plant, a seed, a soil or other growth medium, to improve for agricultural production purposes the physical, chemical, or biological characteristics thereof in order to improve crop production, plant growth, product quality, product durability, or yield prior to harvest. Some commercial formulations of AAIs include organic solvents though, and they may be volatile or hazardous. They may not allow combination of several different AAIs within the same formulation due to incompatibilities. And they may not permit tailoring to a particular crop or soil composition.

There remains a need in the art for an AAI formulation that offers finer control of the controlled release, and that is compatible with the use of multiple agents within the same formulation. There also remains a need in the art for an AAI formulation that is solvent-free, having reduced volatility. There further remains a need in the art for an AAI formulation that allows tailoring of release properties for a given soil, region, crop, etc.

### SUMMARY

Disclosed herein, in embodiments, are formulations comprising an agricultural active ingredient and an ion exchange resin, wherein the agricultural active ingredient is imbibed upon the ion exchange resin. Also disclosed herein, in embodiments, are resinate formulations comprising an agricultural active ingredient and an ion exchange resin, wherein the agricultural active ingredient is imbibed upon the ion exchange resin. In embodiments, the formulation comprises a biodegradable ion exchange resin. In embodiments, the agricultural active ingredient is an anionic or a nonionic or a cationic active ingredient. In embodiments, the agricultural active ingredient is a pesticide or a herbicide. In embodiments, the the agricultural active ingredient is selected from the group consisting of plant nutrients, plant growth regulators, and plant hormones. In embodiments, the ion exchange resin is an anionic ion exchange resin, which can be crosslinked. In embodiments, the ion exchange resin comprises a synthetic polymer or a modified naturally derived polymer. The synthetic polymer can be a crosslinked styrene/divinyl benzene polymer with an ionic comonomer. The modified naturally derived polymer can be a diethylamino ethylcellulose or a carboxymethyl cellulose. In embodiments, the exchange resin comprises non-polymeric particles modified with organic ionic polymers. In embodiments, the resinate formulation is formulated as particles having a particle size distribution in the range of about 0.05 microns to about 5 mm based on median particle diameter, or as particles wherein the particle size distribution is in the range of about 1 to about 200 microns based on median particle diameter. In embodiments, the formulation contains from about 1% to about 99% by weight of the agricultural active ingredient. In embodiments, the formulation contains about 5% to about 70% by weight of the agricultural active ingredient. In embodiments, the formulation contains from about 10% to about 60% by weight of the agricultural active ingredient. In embodiments, the the formulation contains from about 15% to about 50% by weight of the agricultural active ingredient. In embodiments, the formulation further comprises a coating. The coating can comprise a drying oil blend. In embodiments, the formulation is formulated as water-dispersible particles. In embodiments, the formulation is formulated as a suspension of particles in liquid. In embodiments, the formulation further comprises a second agricultural active ingredient.

Further disclosed herein, in embodiments, are methods of manufacturing an agricultural formulation comprising a resinate, comprising: providing an agricultural active ingredient and an ion exchange resin; and mixing the agricultural active ingredient and the ion exchange resin to imbibe the agricultural active ingredient upon the ion exchange resin, thereby forming the resinate. In embodiments, the step of mixing includes imbibing by passive imbibition or imbibing by ionic imbibition. In embodiments, the method further comprises coating the resinate. In embodiments, the step of coating comprises adding a coating material selected from the group consisting of natural oils, starch and amylose-based systems, cellulose and its derivatives, proteins, waxes, and synthetic polymers. In embodiments, the step of coating further comprises modifying the coating based on properties selected from the group consisting of pH sensitivity, UV degradability, and water solubility. In embodiments, the step of coating comprises adding a drying oil blend to a surface of the resinate. The adding of the drying oil blend to the surface of the resinate can take place in a fluidized bed reactor.

Also disclosed herein, in embodiments, are methods of treating an agricultural surface, comprising preparing the formulation as described above containing an amount of an agricultural active ingredient sufficient for treating the agricultural surface; formulating the formulation as a dispersible material, wherein the dispersible material comprises either water-dispersible particles or an aqueous suspension of particles; dispersing the dispersible material in an aqueous vehicle to form a dispensable solution, wherein the dispensable solution contains the amount of the agricultural active ingredient sufficient for treating the agricultural surface; and delivering the dispensable solution to the agricultural surface, thereby treating it. In embodiments, the agricultural surface is a soil surface or a plant surface. In embodiments, the agricultural effective ingredient is a pesticide.

### BRIEF DESCRIPTION OF FIGURES

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a graph showing chloramben concentration in elution fractions.

FIG. 2 is a graph showing benzoic acid concentration in elution fractions.

FIG. 3 is a graph showing benzoic acid concentration in elution fractions.

FIG. 4 is a graph showing chloramben concentration in elution fractions.

FIG. 5 is a graph showing benzoic acid concentration in elution fractions.

FIG. 6 is a graph showing dicamba concentration in elution fractions.

FIG. 7 is a graph showing nicosulfuron concentration in elution fractions.

FIG. 8 is a graph showing imidacloprin concentration in elution fractions.

FIG. 9 is a graph showing gibberellic acid concentration in elution fractions.

### DETAILED DESCRIPTION

Disclosed herein, in embodiments, are formulations and methods for delivering agricultural active ingredients. In embodiments, the formulations comprise resinates based on ion exchange resins and agricultural active ingredients.

As used herein, the term “ion exchange resin” (or “IER”) can refer to an arrangement of polymeric particles having cationic or anionic functional groups capable of complexing with counterions in surrounding media. In embodiments, the IER particles can be in the form of beads, drops, spheres, grains, flakes, needles, and the particles can be solid, hollow, porous, macroreticular, or gelatinous. In embodiments, the IER particles can have a particle size distribution such that the median particle diameter ranges from 0.05 microns to 5 millimeters. In a preferred embodiment, the particle size is in the range of about 1 to about 200 microns based on median particle diameter. In certain embodiments, macroscopic particles in the millimeter range may be suitable. In embodiments, an agricultural active ingredient (AAI) can be mixed with an appropriate ion exchange resin to form an AAI-resin complex (“resinate”). As used herein, the term “resinate” means a complex that is formed between the AAI and the IER. When a resinate is formed, a considerable portion of the AAI can be ionically bound, passively absorbed, and/or adsorbed. When the resinate is applied to agricultural substrates like soil or plants, and is contacted with water, the AAI can be released from the resinate complex via ion exchange, desorption, and/or diffusion mechanisms.

IER can also refer to porous substrates that are made of non-polymeric materials such as ceramics, zeolites, clay minerals, pozzolanic materials, carbonaceous materials such as charcoal and fibrous materials such as cellulose, carbon nanotubes and such, where the internal or external substrate surfaces are modified with an organic ionic polymer. One such modification of the substrate surface would be incorporation of a cationic organic polymer such as polyvinylamine, polyethyleneimine and such into the interstices of the porous substrate. In addition to the synthetic polymer modifiers, natural organic ionic polymers such as chitosan and carboxymethylcellulose can be used to modify the substrate surfaces using pH based precipitation of the polymer in the interstices to improve fastness of polymer modification. In another embodiment, copolymers of styrene-maleimide can be used to modify the surfaces of the porous substrates. The pH mediated solubility of styrene-maleimide copolymers can be used to enhance binding of the copolymer in the surfaces of the porous substrates. In this manner, many porous substrates can be converted into ion binding substrates by modification with organic polymeric reagents for capturing AAI.

The AAI percent loading and subsequent release from the resinate can be adjusted depending on experimental parameters such as those described below. The percent loading is affected by the AAI molecular weight, solubility, concentration, and imbibition time. The release of AAI from the resinate is directly impacted by resin characteristics including size, porosity, functional groups, acid or base strength, ion exchange capacity and degree of crosslinking. For example, the size of the AAI molecules that can penetrate into the resin matrix is strongly contingent on its porosity and extent of crosslinking. A less crosslinked matrix will facilitate the exchange of larger AAIs, but will also release them more rapidly in the presence of competitive counterions. In embodiments, the resinate contains about 1 to about 90% by weight of the AAI. In embodiments, the resinate contains about 5 to about 70% by weight of the AAI. In embodiments, the resinate contains about 10 to about 60% by weight of the AAI. In embodiments, the resinate contains about 15 to about 50% by weight of the AAI. The amount of AAI contained in the resinate is not only governed by the ion exchange capacity of the IER since other loading mechanisms (adsorption, absorption, deposition, precipitation, etc.) contribute to the AAI carrying capacity of the IER.

Hence, the selection of IER for a given AAI directly impacts final performance of the resinate. The choice of ion exchange resin is mainly governed by its functional group properties as either a cation or anion exchanger. In embodiments, the ion exchange resin can be a synthetic organic polymer such as those comprising styrene and divinylbenzene monomers with ionic comonomers. In other embodiments, the IER can be a modified natural polymer such as an ionically modified starch or cellulose. For example, diethylaminoethyl cellulose (DEAE-C) is a modified natural polymer that can be used as an ion exchange resin. The IER can be modified with different levels of the ionic comonomer(s) to adjust its ion exchange capacity. Certain IER products that are well known and widely used in industrial and water treatment applications can be used to make a resinate comprising an AAI. For example, an anionic IER, such as DOWEX®, Type 1 and AMBERLITE®, Type 1 and the like, is suitable for use with anionic AAIs, where such anionic AAIs may include molecules such as those classified as synthetic auxins (dicamba, chloramben, trichlorobenzoic acid (TBA) etc.), cytokines, gibberellins, etc. In other embodiments, cationic or nonionic AAIs (e.g., sulfoxaflor) can be absorbed into appropriate IERs. Anionic AAIs can also include nutrients such as phosphate ions.

In embodiments, a resinate in accordance with the present invention can be prepared by selecting an appropriate resin, and combining it with an effective amount of an AAI in a solution. The solution of AAI can be an aqueous solution or it can be an organic-solvent-based solution. In the case of organic solvent based solutions, the residual solvent should be removed from the resinate before it is deployed in an agricultural setting. After combining the resin and the AAI, the residual solvent can be removed by filtration or evaporation, yielding a resinate of IER and AAI. IER can be manufactured with different levels of crosslinking to alter the physical properties such as porosity, density, and ion exchange capacity. In general, a higher level of crosslinking tends to reduce the permeability of fluids into and out of the resin and results in a relatively hard, nonswellable resin. A lower level of crosslinking tends to increase permeability of fluids into and out of the resin and results in a relatively soft, swellable resin. These permeability and swelling properties can impact the loading and release properties of an AAI onto the IER. Since DOWEX® 1×8 is more highly cross-linked, it will swell more slowly. This will make it take longer to expose the linked AAI to counterions and consequently release the AAI much more slowly than the DOWEX 1×2, which is less cross-linked. Because DOWEX 1×2 is less cross-linked, it will also have a larger void space than the DOWEX 1×8 resins and will thus have more AAI passively imbibed. The passively imbibed AAI will release more quickly than the bound AAI because it can diffuse out of the resin without having to exchange with a counterion.

In embodiments, resinate formulations can be prepared that are biodegradable. As used herein, the term “biodegradable” refers to a substance that is capable of chemical dissolution by biological materials such as bacteria, fungi, protozoa, or the like. For a biodegradable resinate formulation, a biodegradable AAI and a biodegradable IER resin would be used. A wide variety of biodegradable substances for AAIs and for IER resins would be familiar to those having ordinary skill in the art. Examples of biodegradable AAIs include diethylaminoethyl cellulose and carboxymethyl cellulose.

For the selected AAI, it can be associated with the IER by optimizing preparation conditions. In embodiments, one can first purify the resin and exchange the counterion into the hydroxide form via a column technique. The IER can then be mixed with one or more suitable AAI molecules to form the resinate. The AAIs can adhere to the resin via passive absorption or actual ion exchange from the imbibition media, which may include water or other solvents in which the AAI has some degree of solubility.

To form a resinate, defined as the complex between the AAI and the IER, the IER resin is mixed with one or more types of AAI compounds. This can be carried out by either passive or ionic forms of imbibition. Passive imbibition occurs when an AAI enters the pores of the IER and remains trapped inside after washing and solvent evaporation. Ionic imbibition occurs when an ionic linkage forms between the charged AAI and oppositely charged ionic functional groups of the resin, present on both the exterior surface and interior pore surface of IER. The imbibition phase may be water or any solvent in which the AI has partial or complete solubility.

A protocol for preparing a resinate in accordance with the invention can involve a 1:1 (by weight) mixture of the AAI and IER in a given volume of an appropriate solvent. This slurry can be shaken for a period of hours up to several days, depending on the desired percent loading. This loading can also be altered by changing the ratio of the AAI to resin. The resinate can then be recovered via vacuum filtration and washing with acetone to remove any unbound AAI.

The resinate can then be further dried to form flowable particles. The resulting water dispersible granules can be more easily handled than a finely milled, flaky, unformulated AAI. It can also be formulated as a suspension of resinate particles in water, such that the suspension that can be readily dispersed into water for spraying on agricultural materials. A concentrated suspension of resinate particles can be described as a “high suspension concentrate” (HSC). After the resinate is formulated for delivery in granular or suspension form, it can be applied to soil or plant surfaces to prevent unwanted colonization with pests, weeds, etc. In embodiments, formulations as described herein can be supplied in the dry particulate form or as an aqueous suspension. Typically, solid agrochemical formulations known in the art are used in conjunction with wetting and dispersing agents. Suspension concentrates of agrochemicals known in the art usually use such auxiliaries too, in addition to adjuvants, as well as defoamers, thickeners, preservatives and antifreeze products. The use of resinate formulations as disclosed herein circumvents the need for some of these additives, as they are easily dispersed into an aqueous vehicle like water.

One could use a variety of different stabilizers to create a stable suspension, including thickening agents such as cellulosic stabilizers, xanthan gum, guar gum, etc. Buffers and acidifiers may be formulated into the suspension or added upon dilution to ensure that the pH remains at the desired level for the stability of the AAI.

Additional control of the AAI release kinetics can be achieved by applying a protective coating to the resinate. Preparing the resinate as a coated resinate can modify the sustained-release properties of the AAI-resin complex. Coating the resinate can help prevent excess AAI from being released and washed away into the ground water, while maintaining AAI levels high enough so as to provide effective treatment. Solvent-based, aqueous-based, or dry coatings can be applied to the AAI-resin complex. Coating materials can be water-soluble or water-insoluble. Water-insoluble coating materials including drying oils (such as linseed oil, poppy oil, perilla oil, walnut oil or other similar oils) (incorporating plasticizers, with or without additional crosslinking) can be applied. Plasticizers can be added to the resinate coating, including glycerol, propylene glycol, polyethylene glycol, polypropylene glycol, and the like.

Biodegradable materials can be used for the resinate coating, such as starch and amylose-based systems, cellulose and its derivatives, proteins, waxes, synthetic polymers (e.g., polyvinyl alcohol, polyamines etc.), and the like. The coating material can form a film that acts as a barrier to slow the release of the AAI, and the rate of AAI release can be adjusted based on the coating thickness or other properties of the coating such as pH sensitivity, UV degradability, water solubility, etc. In certain embodiments, a coating material film can be selected to accelerate the release of an AAI, where the AAI has an affinity for the film or a solubility in the oil overcoat.

AAIs such as pesticides, fertilizers, and the like can suffer leaching due to excessive watering. By trapping the nutrients within an IER, a formulation can establish an equilibrium with the soil cations, so that the nutrients are more readily accessible to the plant. As an example, such a formulation could comprise an IER formulated with cation exchangers imbibed with e.g., nitrogen, potassium, calcium, magnesium, and iron, among others. The resinate may also include an anionic AAI (e.g., dicamba, abscisic acid, chloramben etc.) that is released by exchange with mobile soil anions such as chlorine, nitrate, sulfate and phosphate. In this way, the crop receives both protection and nutrition simultaneously.

In embodiments, by varying parameters such as IER composition or coating material, one can customize a formulation for an IER-imbibed AAI so that there are several different release profiles for the agent. As an example, a given resinate could release one or more AAI compounds in an initial burst, while another resinate might prolong the release of one or more AAI compounds over several days to weeks. In this way, the one or more AAIs can be included in a formulation that is specific for a particular crop, climate, soil etc.

A coating that encapsulates an AAI-resin complex can also alter the rate at which equilibrium can be achieved in the soil, by controlling the wetting of the resin. When the

AAI-resin complex is wetted and exposed to the ions dissolved in the soil, the bound AAI may become unbound when the ions in the soil migrate into the IER and displace the AAI compound. The release of the AAI from the IER is governed by equilibrium and is subject to variables known to those skilled in the art.

This is of particular relevance for designing IERs for use in various soils. Soil is made up of components such as clay, silt, sand, organic matter, and humus particles, that have surfaces that can retain positively charged species, such as potassium, calcium, magnesium, and various nutrients. The soil's ability to hold and release various cations is termed its cationic exchange capacity. In soils with normal cation exchange capacity, the exchange of an AAI for ions in the soil will be governed by soil dynamics, while in soils with higher than usual ionic strength (e.g. salty soils), diffusion becomes the rate limiting step. Other influences that affect the release of the AAI from the IER are hydration of the IER, IER affinity for the AAI, and IER affinity for other ions in the soil. If the cation exchange capacity of the soil is known, one can further engineer the formulation to include macro- and micro-nutrients.

In embodiments, the resinate can be applied to agricultural surfaces and the release of AAI from the resinate is governed by the amount of precipitation or irrigation that contacts the resinate. In the case of precipitation, rainwater contains very little dissolved salts so direct contact of the resinate with rainwater will not displace all of the ionically bound AAI. This can be an advantage of the resinate since a heavy rain event with active surface runoff will not desorb the AAI from the resinate; however, given time for the rainwater to interact with the soil, the salt-laden water emanating from the soil will desorb AAI by ion exchange.

In embodiments, resinate formulations as described herein can be supplied in the particulate form, as water dispersible granules, or as an aqueous suspension. In embodiments, the resinate formulations can be dispersed into water for spraying onto agricultural substrates, and the water can contain adjuvants to improve properties of the sprayable solution. Adjuvants are chemicals that are typically formulated alongside an AI to improve mixing, application and enhance its performance. In foliar applications adjuvants are used to customize the formulation to the specific needs of the environmental conditions. For example, a “sticker” is an adjuvant that encourages the adhesion of solid granules to a target surface such as foliage. In embodiments, a “sticker” can be applied to the surface of the resinate such that dual performance is achieved, i.e., controlled release along with directed attachment to a specific surface.

In certain embodiments, the resinate formulations described herein can be of particular use with herbicides. Herbicides are prone to drift during application either via particles, aerosols, or vapors. Physical drift is the movement of liquid spray droplets away from the target crop and is highly influenced by spray equipment and wind conditions. By contrast, resinates described herein are dense so they are less prone to physical drift. Vapor drift is the movement of volatilized AAI away from the target after application of the formulated herbicide. Vapor drift is primarily influenced by the vapor pressure of the AAI, temperature and humidity. In embodiments, entrapping the AAI in a resinate complex, along with coating it as described above, prevents it from volatilizing as readily, thereby decreasing vapor drift.

### EXAMPLES

Materials used in these examples include:
DOWEX® 1×2 ion exchange resin, DOW, Midland, Mich.
DOWEX® 1×8 ion exchange resin, DOW, Midland, Mich.
NaOH, Sigma Aldrich, St. Louis, Mo.
Methanol, Sigma Aldrich, St. Louis, Mo.
Acetone, Sigma Aldrich, St. Louis, Mo.
Chloramben, Sigma Aldrich, St. Louis, Mo.
Silica gel, Sigma Aldrich, St. Louis, Mo.
Erisys GE-35H Epoxidized Castor Oil, CVC Thermoset specialties, Moorestown, N.J.
Linseed Oil, Sigma Aldrich, St, Louis, Mo.
JEFFAMINE® T3000, Huntsman, Salt Lake City, Utah
Sand
Rubinate M (Polymeric MDI), Huntsman, Salt Lake City, Utah
Triethylenetetramine (TETA), Sigma Aldrich, St. Louis, Mo.
AMBERLITE® IRA743, Sigma Aldrich, St. Louis, Mo.
Organic potting mix, Fafard, Agawam, Mass.
Sand 20-40 mesh, EMD Millipore, Billerica, Mass.
Filter paper, 5.5 cm 1 μm pore size, VWR, Radnor, Pa.
Tween 80, Sigma Aldrich, St. Louis, Mo.
Pluronic L64, BASF, Ludwigshafen, Germany
Aerosil 380, Evonik, Essen, Germany
BYK-7420, ALTANA AG, Wesel, Germany
Benzoic acid, Sigma Aldrich, St. Louis, Mo.
Sodium benzoate, Spectrum, New Brunswick, N.J.
Dicamba, BOC Sciences, Shirley, N.Y.
Nicosulfuron, BOC Sciences, Shirley, N.Y.
Imidacloprid, BOC Sciences, Shirley, N.Y.
Gibberellic acid, BOC Sciences, Shirley, N.Y.

### Example 1

### Preparation of 2M NaOH Solution

In the following Examples, deionized water was prepared using a Direct-Q ultrapure water system (EMD Millipore, Billerica, Mass.). A key ingredient in the purification of the IER is a 2M NaOH solution. Table 1 sets forth the materials for the preparation of the 2M NaOH solution.

TABLE 1

| | | |
|---|---|---|
| NaOH | 80 | g |
| Deionized water | 1 | L |

2M NaOH was formulated by adding 80 g of NaOH to a 1 L jar fitted with a stir bar. Next 1 L of water is poured into a jar and the solution is allowed to stir on a stir plate until the NaOH has completely dissolved.

### Example 2

### IER Preparation

TABLE 2

| | | |
|---|---|---|
| DOWEX 1x8 resin | 80 | g |
| Deionized water for the slurry | 120 | mL |
| Methanol | 500 | mL |
| 2M NaOH | 500 | mL |
| DI water for the column | 800 | mL |
| Deionized water for vacuum filtration | 200 | mL |

Using the materials set forth in Table 2, the IER resin (DOWEX 1×8) was purified and the counterion was exchanged by a column method to maximize AAI loading. The IER particles were slurried in deionized water and the mixture was allowed to soak while being agitated on a shaker for a sufficient time to swell the resins, approximately 12-24 hours. The slurry was then poured into a glass column fitted with a glass frit at the bottom. First, methanol was passed through the column until the eluate went from transparent yellow to clear and colorless, followed by 2 M NaOH, until the eluate reached a pH of 14. Finally, DI water was passed through the column until the eluate reached a neutral pH. The purified IER particles were recovered via vacuum filtration. The IER resin particles were not dried in order to maintain their swollen state.

### Example 3

### Preparation of a Resinate

TABLE 3

| Materials | Amounts | |
|---|---|---|
| Imbibition phase | 50-1000 | mL |
| Ion Exchange Resin (IER) | 1-50 | g |
| AAI | 1-50 | g |
| Acetone for post wash | 40-200 | mL |

General principles for preparing a resinate are set forth below. The resinate can be prepared using the materials listed in Table 3. The imbibition phase may be water, acetone or any solvent in which the AAI has partial or complete solubility. Unless otherwise noted, all resinates described here are prepared with a 1:1 ratio of AAI:IER. The AAI (dissolved in the appropriate imbibition phase) and IER are slurried on a shaker for a sufficient amount of time for the AAI to imbibe into the resin, typically 24 hours. Post imbibition, the resinate is vacuum filtered and washed with acetone to remove any unbound AAI. The isolated resinate is subsequently dried in a vacuum oven overnight. The drying of the resinate may be achieved using various other processes known to persons of skill in the art, including air drying, fluidized bed techniques, microwave, oven drying etc.

### Example 4

### Preparation of a Chloramben-Based Resinate (WG01)

A chloramben loaded IER complex (designated herein as WG01) was prepared using the protocol described in Example 3. Chloramben (50 g) was dissolved in 1000 mL of water and slurried with 50 g of DOWEX 1×2 resins overnight (i.e., ˜24 hours). The resulting resinate was vacuum filtered, washed with acetone, and dried overnight. The retrieved resinate was then post-coated with a mixture of drying oils and crosslinker as described below, to further enhance its controlled release.

### Example 5

### Post-Coating Technique Using a Drying Oil Blend

TABLE 4A

| | |
|---|---|
| Epoxidized Castor Oil (ECO) | 10 g |
| Linseed Oil (LO) | 10 g |

Using the materials set forth in Table 4A, a mixture of epoxidized castor oil (ECO) and linseed oil (LO) was prepared by weighing 10 g of ECO into a glass vial followed by 10 g of linseed oil. The combined oils, representative of a drying oil blend, were then vortexed to ensure adequate mixing.

TABLE 4B

| | |
|---|---|
| Resinate WG01 (from Example 4) | 5 g |
| Silica gel | 5 g |
| ECO:LO mixture (described above in Table 4A) | 3 g |
| Jeffamine T3000 (T3000) | 1 g |

Then, using the materials set forth in Table 4B, a coated resinate was prepared. The resinate from Example 4 (WG01) and silica were weighed into a FlackTek cup and were mixed on a SpeedMixer for 30 seconds at 4,000 rpm. Next the ECO:LO drying oil blend was added to the resinate/silica mixture. This was then spun on the SpeedMixer for 30 seconds at 4,000 rpm. Finally, Jeffamine T3000 was added to the mixture and it was spun for 30 seconds at 4,000 rpm. Then the coated resinate was put in a 50° C. oven for 12 hours to cure the coating.

### Example 6

### Fluidized Bed Coating

A fluidized bed coating technique can be used to coat a resinate with a drying oil blend, as described below. In this Example, a blend of drying oils can be sprayed onto the fluidizing AAI-resin complex, encapsulating the resinate particles with a tunable coat weight. The drying oils can be mixed with an appropriate solvent or left undiluted. Additionally, a cross-linker can be applied. The drying oils can be mixed with a cross-linker or a cross-linker can be applied as a second coat. If the cross-linker is applied as a second coat, it can be mixed with an appropriate solvent or undiluted.

TABLE 5A

| | | |
|---|---|---|
| Resinate (from Example 4) (WG01) | 500 | g |
| (ECO:LO) (from Example 5, Table A) | 150 | g |
| Ethanol | 20 | g |

A non-crosslinked encapsulated resinate can be produced using the materials set forth in Table 5A. The resinate from Example 4 (WG01) can be encapsulated in a solvent-diluted drying oil blend, with no cross-linker. First, the ECO:LO drying oil blend is mixed with the ethanol to create the coating mixture. The resinate (WG01) is placed in a fluidized bed reactor and is fluidized using hot intake air. The temperature of the intake air is elevated to a level that encourages the drying oil to polymerize, but not so hot that it volatilizes or degrades the AAI (approximately 80 degrees C.). The coating mixture is sprayed on the fluidized resinate at a rate of 5 g/min until all of the coating mixture is applied. To achieve an adequate degree of polymerization of the drying oils, fluidization is continued with heated air for 15 minutes after the last of the coating mixture had been applied, for a total of approximately 30 minutes total processing time.

TABLE 5B

| | | |
|---|---|---|
| Resinate (from Example 4) (WG01) | 500 | g |
| ECO:LO (from Example 5, Table A) | 150 | g |
| T3000 | 50 | g |
| Ethanol | 20 | g |

A crosslinked encapsulated resinate can be produced using the materials set forth in Table 5B. The resinate from Example 4 (WG01) can be encapsulated with a solvent diluted drying oil blend that includes a cross-linker. First, the ECO:LO drying oil blend is mixed with the polyetheramine and ethanol to create the coating mixture. The resinate is placed in a fluidized bed reactor and was fluidized using hot intake air. The coating mixture is sprayed on the fluidized resinate at a rate of 5 g/min until all of the coating mixture is applied. Subsequently, fluidization with the heated air is continued for 15 minutes after the last of the coating mixture had been applied, for a total of approximately 30 minutes of processing time.

### Example 7

### Dry Formulations

Both the coated and uncoated resinates, and combinations thereof, can be formulated into water dispersible granules (WDG), as described below. These WDG are suitable for sprinkling on the soil as a granular formulation or for dispersal in water to be applied as a spray formulation. For this Example, WG01 was prepared, as described above in Example 4. In addition, a second chloramben-based resinate was prepared as described below, designated WG02.

For the preparation of WG02, the protocol set forth in Example 3 was followed. Specifically, chloramben was dissolved in 1000 mL of water and slurried with 50 g of DOWEX 1×8 resins overnight (i.e., ˜24 hours). The resinate was vacuum filtered, washed with acetone, and dried overnight. The retrieved resinate was then post-coated with the oil blends described in Example 5 to further enhance its controlled release.

TABLE 6A
(Sample WG01)

| | |
|---|---|
| AAI-DOWEX 1x2 complex (WG01) | 50 g |

TABLE 6B
(Sample WG02)

| | |
|---|---|
| AAI-DOWEX 1x8 complex (WG02) | 50 g |

The dry formulations described in Tables 6A and 6B had been placed in plastic FlackTek cups to store them. Mixtures were then formed by combining two resins (as described below) in a FlackTek cup and spinning at 500 rpm for 30 seconds. The mixture of WG01 and WG02, as described in Table 6C, formed Sample WG03. The mixture of WG01 and the coated resin prepared in Example 5 is described in Table 6D, and is designated as WG04.

TABLE 6C
(Sample WG03)

| | |
|---|---|
| AAI-DOWEX 1x2 complex (WG01) | 25 g |
| AAI-DOWEX 1x8 complex (WG02) | 25 g |

TABLE 6D
(Sample WG04)

| | |
|---|---|
| AAI-DOWEX 1x2 complex (WG01) | 25 g |
| AAI-DOWEX 1x2 + 21% ECO:LO | 25 g |
| complex + 7% T3000 (from Example 5) | |

Tables 6C and 6D offer other examples of ways to formulate WDG. Table 6C exemplifies mixing of resins that have two different levels of crosslinking. Table 6D exemplifies mixing uncoated and coated resins; in such a mixture, the coated resin can modify the release of the AI compared to the uncoated resin, resulting in an extended length of sustained release of AI.

### Example 8

### High Suspension Concentrate

Both the coated and uncoated resinate complexes as prepared in the Examples above, and combinations thereof, can be formulated into high suspension concentrates (HSCs). These robust aqueous concentrates maintain the integrity of the sustained-release properties of the resinate. These HSC can subsequently be diluted and sprayed.

TABLE 7A
(Sample HSC01)

| | |
|---|---|
| AAI-DOWEX 1x8 complex (WG02) | 40 g |
| Deionized water | 60 g |

Table 7A lists the ingredients for formulating a HSC, here designated as HSC01. To make this formulation, 40 g of WG02 was placed into a glass jar. Subsequently, 60 g of water was added. If further stability of the suspension is required, surfactants and viscosity modifiers can be added.

TABLE 7B
(Sample HSC02)

| | |
|---|---|
| AAI-DOWEX 1x2 complex WG01 | 20 g |
| AAI-DOWEX 1x8 complex WG02 | 20 g |
| Deionized water | 60 g |

Table 7B lists the ingredients for forming another HSC, here designated as HSC02. To make this formulation, 20 g of WG01 is weighed out into a glass jar, followed by 20 g of AAI-DOWEX 1×8 complex. Subsequently, 60 g of water can be added. If further stability of the suspension is required, surfactants and viscosity modifiers can be added.

### Example 9

### Agricultural Active Ingredients

TABLE 8

| AAIs | Resins |
|---|---|
| dicamba, chloramben, cambendichlor, | DOWEX 1x2 |
| 2,3,6-TBA, tricamba | |
| Abscisic acid | DOWEX1x8 |
| | AMBERLITE IRA743 |

Table 8 is a representative list of active ingredients that may be used in combination with resinates as described herein. Other resins may also be suitable, including those where the AAI is modified to achieve a specific property, or a particular chemical group found on the AAI is modified. In various embodiments, agricultural active ingredients having ionic character can be imbibed into a DOWEX® or AMBERLITE® brand resin.

### Example 10

### Soil Evaluation

Certain coated and uncoated resinates, prepared in accordance with the Examples above, were evaluated under conditions that mimic those found in the soil. The chloramben control was also evaluated in this way.

To assess the extended release properties of our WDG and HSC formulations (prepared in accordance with Example 7) we employed a sand column method as described below, where the results of the sand column test can be extrapolated to represent in vivo soil conditions.

Sand column tests were run first with water and then with a 2M NaOH ionic solution. Running the sand column test with water demonstrated that the majority of the AAI was actively bound to the resin and remained bound if there were no ions present. The rest of the sand column tests were then run with 2M NaOH; we selected the hydroxyl ion as a representative anion to illustrate the release of the AAI through ion exchange.

TABLE 9

| Sand for column | 9 | g |
|---|---|---|
| Deionized water to slurry the sand | Enough water to create the | |
| | slurry (10 mL) | |
| Sand to mix with formulation | 3 | g |
| WG01 | 60 | mg |
| Deionized water to slurry the sand and | 3 | mL |
| WG01 | | |
| Deionized (DI) water to run the column | 70 | mL |
| 2M NaOH to run the column (formulated | 70 | mL |
| as described in Table 1) | | |

To run the sand column, the following protocol was used, using the ingredients as set forth in Table 9. First, the sand to be used in the sand column was weighed out into a centrifuge tube. Then the sand was wetted with DI water until flowable and vortexed to mix. Next, the sand was introduced into a Lab-Crest Buret fitted with a Stopcock. DI water was then passed through the sand column to remove any sand that had stuck to the side of the buret. Excess water was drained, until the water level was just at the top of the sand. In a separate small centrifuge tube, the sand was mixed with the experimental sample, and this mixture was added to the top of the sand column. Chloramben control and samples formulated as WG01, WG02, and HSC01 (as described above) were tested.

For each Sample, the experiment was conducted as follows. As previously described, DI water was added with a syringe pump in sufficient quantity (approximately 8-10 mL) to ensure the column did not run dry, and that there was a constant surface pressure. 7×10 mL fractions were collected from the column in appropriately sized culture tubes at 10 mL fractions. The stopcock was closed as the water level reached the top of the sand. Then, using a syringe pump, enough 2M NaOH (approximately 8-10 mL) was added to ensure the column did not run and dry and that there was a constant surface pressure. 7×10 mL fractions were collected in appropriately sized culture tubes. Each fraction was then analyzed for UV absorbance at 200-400 nm using a ThermoScientific model Evolution 201, diluting samples when necessary. Comparing the absorbance values against a calibration curve, the amount of AAI in each fraction was calculated.

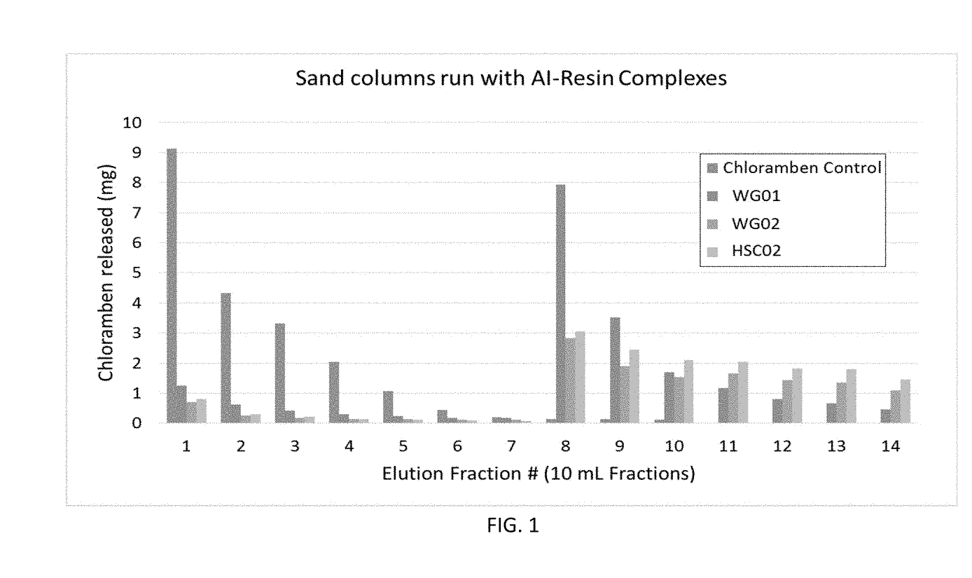

The results of these experiments are shown in the graph in FIG. 1. FIG. 1 shows a comparison of the release curves of chloramben imbibed resins passed through a sand column, first with DI water, to demonstrate how well bound the AAI are to the ion exchange resin, and then with a 2M NaOH solution to demonstrate how the majority of the AAI is released when ions are available to exchange.

The graph in FIG. 1 shows the release profiles for the resinate formulations WG01, WG02, and HSC01. Fractions 1-7 were run with deionized water flushing through the column, while fractions 8-14 were run with 2 M NaOH flushing through the column. The arrow indicates where the changeover from DI water to NaOH occurred. The graph shows that the control chloramben powder (prepared as described above in Example 10 and evaluated using the sand column described above) is released very quickly, while the WG01, WG02, and the HSC01 exhibit varying degrees of extended release. Only when there was a counterion present for exchange (i.e. OH⁻ in the NaOH), did the chloramben in the test samples start to release more quickly.

TABLE 10

| | | | Post | | Post | | Post |
|---|---|---|---|---|---|---|---|
| | | DI water | NaOH | DI water | NaOH | DI water | NaOH |
| | Control | WG01 | WG01 | WG02 | WG02 | HSC01 | HSC01 |
| % loading | 100% | 40% | 40% | 35-40% | 35-40% | 5-6% | 5-6% |
| Total mg | 20.92 | 3.16 | 16.26 | 1.64 | 11.78 | 1.76 | 14.7 |
| chloramben | | | | | | | |
| released | | | | | | | |
| % chloramben | 44% | 8% | 45% | 2% | 10-11% | 2% | 11-13% |
| released in first | | | | | | | |
| two fractions | | | | | | | |
| % total | 70% | 78% | 78% | 29-32% | 29-32% | 34-39% | 34-39% |
| chloramben | | | | | | | |
| released | | | | | | | |
| % chloramben | 30% | 12% | 12% | 68-71% | 68-71% | 61-66% | 61-66% |
| remaining | | | | | | | |

Table 10 provides more details about what is depicted in FIG. 1. The control was released more quickly than the Sample formulations (WG01, WG02, HSC01). Of the Samples, WG01 released more quickly and had a slightly higher loading than the WG02 and HSC01 formulations because it was made up with the DOWEX 1×2 resins, while WGCE02 and the HSC02 were made up with the DOWEX 1×8 resins. Because the DOWEX 1×8 resins are more cross-linked and have less void space, they have a lower loading and slower release properties.

### Example 11

### Other Resinate Complexes Made for Release Testing

Because release of the AAI from the resinate is partly dependent on the particle size of the resin and the affinity of the AAI for the binding site in the resin, we tested resins of various sizes with different active ingredients. Sizes of representative IERs are shown in Table 11.

TABLE 11
Representative IER Sizes

| Resin | Size (um) |
|---|---|
| DOWEX 1x2 | 50-150 |
| DOWEX 1x8 | 50-150 |
| Powdered Resins | <10-150 |
| AMBERLITE IRA-743 | 500-700 |

For this Example, WG05 was made according to the procedure delineated in Example 3. To formulate WG05, chloramben (1 g) was dissolved in 40 mL of acetone and slurried with 1 g of powdered resin for 24 hours. The resinate was vacuum filtered, washed with acetone, and dried overnight. WG06 was made according to the procedure delineated in Example 3, whereby DOWEX 1×8 resin was imbibed with benzoic acid. Benzoic acid (4 g) was dissolved in 200 mL of acetone and slurried with 4 g of DOWEX 1×8 resins for 24 hours. The resinate was vacuum filtered, washed with acetone, and dried overnight. WG07 was made according to the procedure delineated in Example 3, whereby powdered resin was imbibed with benzoic acid. Benzoic acid (1 g) was dissolved in 40 mL of acetone and slurried with 1 g of powdered resins for 24 hours. The resinate was vacuum filtered, washed with acetone, and dried overnight. WG08 was made according to the procedure delineated in Example 3, whereby AMBERLITE IRA-743 resin was imbibed with benzoic acid. Benzoic acid (50 g) was dissolved in 100 mL of acetone and slurried with 25 g of powdered AMBERLITE IRA-743 resins for 24 hours. The resinate was vacuum filtered, washed with acetone, and dried overnight. Benzoic acid was chosen as a model compound that represents the chemical structure of the auxin class of herbicides.

### Example 12

### Preparation of Coated Resin WG09 Using Polyurea

TABLE 12
Ingredient amounts for Example 12

| | | |
|---|---|---|
| Resinate complex WG06 (from Example 9) | 1.5 | g |
| Silica gel | 1.5 | g |
| Rubinate M | 134 | mg |
| Triethylenetetramine (TETA) | 414 | mg |

For this Example, the ingredient proportions set forth in Table 12 were used to prepare the following formulation. The WG06 resinate complex from Example 11 and silica were weighed into a FlackTek cup and mixed on a SpeedMixer for 30 seconds at 3,000 rpm. Next the Rubinate M was added drop-wise to the resinate/silica mixture. This was then spun on the SpeedMixer for 30 seconds at 3,000 rpm. Finally, the TETA was added to the mixture and it was spun for 30 seconds at 3,000 rpm. Then the coated resinate was put in a 100° C. oven for 30 minutes to cure the coating. The final coat weight of the WG09 was ˜15% polyurea.

TABLE 13
Ingredient amounts for Example 13

| | |
|---|---|
| Resinate complex WG08 (from Example 11) | 5 g |
| ECO:LO mixture (from Example 5) | 2 g |
| T-3000 | 1 g |

For this Example, the ingredient proportions set forth in Table 13 were used to prepare the following formulation. The resinate complex WG08 from Example 11 was weighed into a FlackTek cup. Next the ECO:LO mixture (Example 5) was added drop-wise to the resinate. This was then spun on the SpeedMixer for 30 seconds at 3,000 rpm. Finally, the T3000 was added to the mixture and it was spun for 30 seconds at 3,000 rpm. Then the coated resinate was put in a 50° C. oven for 12 hours to cure the coating. The final coat weight of the WG10 was ˜37.5% crosslinked drying oils.

### Example 14

### Determining AAI Loading of Resinate Complexes

The percent loading for each AAI was determined by running a sand column with a solution that had a high concentration of ions. The loading was determined for the WG01, WG02, and WG05 through WG10 inclusive. The materials and equipment necessary to ascertain the loading of the samples are listed in Table 14.

TABLE 14

| | |
|---|---|
| Sand for column | 9 g |
| Deionized water to slurry the sand | Enough water to create the |
| | slurry (10 mL) |
| Sand to mix with formulation | 3 g |
| AAI Resinate Sample (WG01, WG02, | 60 mg |
| WG05-WG10) | |
| Deionized water to slurry the sand and AI | Enough water to create the |
| Resinate Sample | slurry (3 mL) |
| 2M NaOH to run the column (formulated | Enough to wash all the ions |
| as described in Table 1) | through (420-600 mL) |

In this example, a 2 M NaOH solution was used to determine percent loading. In this protocol, the sand column was run until all of the AAI was released from the resinate and exchanged with the ions in the solution. This typically required between 14 and 20 fractions, each measuring a volume of about 30 mL. To set up the sand column, the sand was weighed into a centrifuge tube. Then the sand was wetted with DI water until flowable and vortexed to mix. Next, the sand was added into a Lab-Crest buret fitted with a stopcock. DI water was passed through the sand column to remove any of the sand that stuck to the side of the buret. The excess water was drained until the water level was just at the top of the sand. In a separate small centrifuge tube, the sand was mixed with the resinate and added to the top of the sand column. Then the 2 M NaOH solution was pipetted into the top of the column to ensure the column did not run dry and that there was a constant surface pressure. Each 30 mL fraction was collected in the appropriately sized culture tubes. Each fraction was then analyzed for UV absorbance at 200-400 nm using a ThermoScientific model Evolution 201, diluting samples when necessary. Comparing the absorbance values against a calibration curve, the amount of AAI in each fraction was calculated. The % loading was determined and is summarized in Table 15:

TABLE 15

| WG Number | % Loading |
|---|---|
| WG01 | 41 |
| WG02 | 30 |
| WG05 | 46 |
| WG06 | 30 |
| WG07 | 46 |
| WG08 | 22 |
| WG09 | 30 |
| WG10 | 14 |

### Example 15

### Conducting Soil Tests to Determine in Vivo Release Profile of Resinate Complexes

To further explore behavior of the IER-AAI complex in conditions found in the soil, a soil test was developed to mimic in-vivo conditions by mixing potting soil with sand, based on the understanding that most soil in the field is not of the same quality as premium potting soil, but instead typically contains more clay or sand. The samples run through the soil test were WG01, WG02, WG05-WG10. The materials and equipment necessary to run the soil test are listed in Table 16.

TABLE 16

| Potting soil | 2.5 | g |
|---|---|---|
| White sand 200-400 mesh | 4 | g |
| Buchner funnel | n/a | |
| Erlenmeyer flask | n/a | |
| Rubber adaptors | n/a | |
| 5.5 cm filter paper with 1 um pore size | n/a | |
| Tap water | 100 | mL |
| AAI Resinate Sample (WG01, WG02, and | 60 | mg |
| WG05-WG10) | | |

In this experiment, potting soil was mixed with sand in a 19:31 ratio. Then the desired amount of IER-AAI complex (the amount of resin that would allow the total AAI to be 25 mg) was mixed homogenously in with the soil. The Buchner funnel was fitted with filter paper and the filter paper was wet with a little bit of tap water. The Buchner funnel was then placed in an Erlenmeyer flask with a side arm fitted with a rubber adaptor. The side arm was hooked up to a vacuum and the vacuum turned on. Next, the sand/soil/IER-AAI mixture was poured into the Buchner funnel. 10 mL of tap water was poured evenly over the sand/soil/IER-AAI mixture and flooding was observed. Once the water drained into the Erlenmeyer flask, the Buchner funnel was removed and the water transferred into a glass vial. The Buchner funnel was replaced back on the Erlenmeyer flask, the vacuum turned back on, and another 10 mL of tap water was poured evenly over the sand/soil/IER-AAI mixture. This process was repeated until 10×10 mL fractions were collected. Each fraction was then analyzed for UV absorbance at 200-400 nm using a ThermoScientific model Evolution 201, diluting samples when necessary. Comparing the absorbance values against a calibration curve, the amount of AAI in each fraction was calculated.

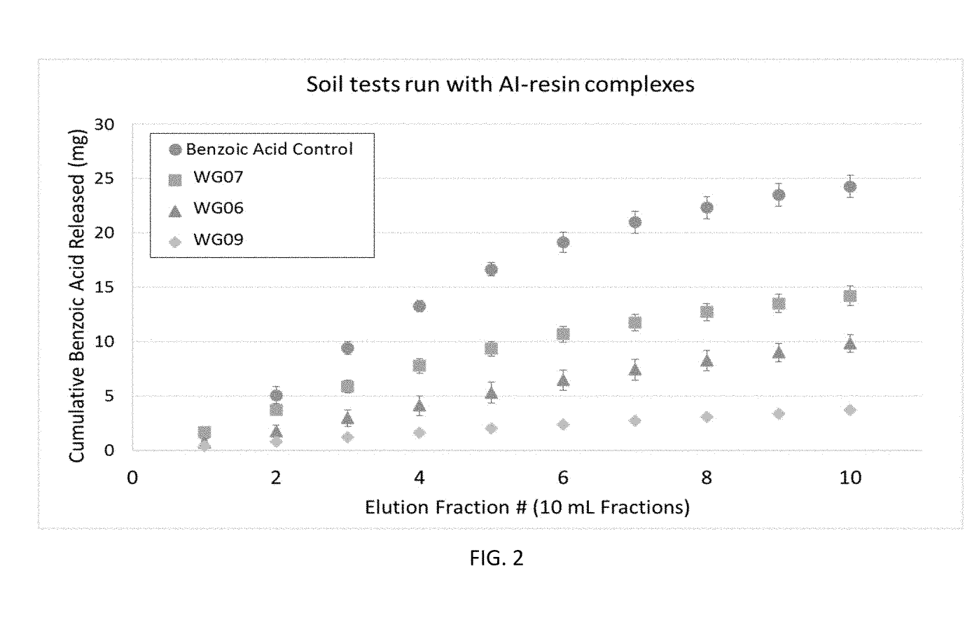

The AAI release profiles of the coated resinates, uncoated resinates and controls are shown in FIGS. 2-4.

The total release of AAIs obtained from the soil tests is summarized in Tables 17-19.

TABLE 17
(References samples whose release profiles are shown in FIG. 2)

| | Total AAI Released | Percent |
|---|---|---|
| Sample Name | (mg) | Released |
| Benzoic Acid | 24 | 97% |
| Control | | |
| WG07 | 14 | 57% |
| WG06 | 10 | 39% |
| WG09 | 4 | 15% |

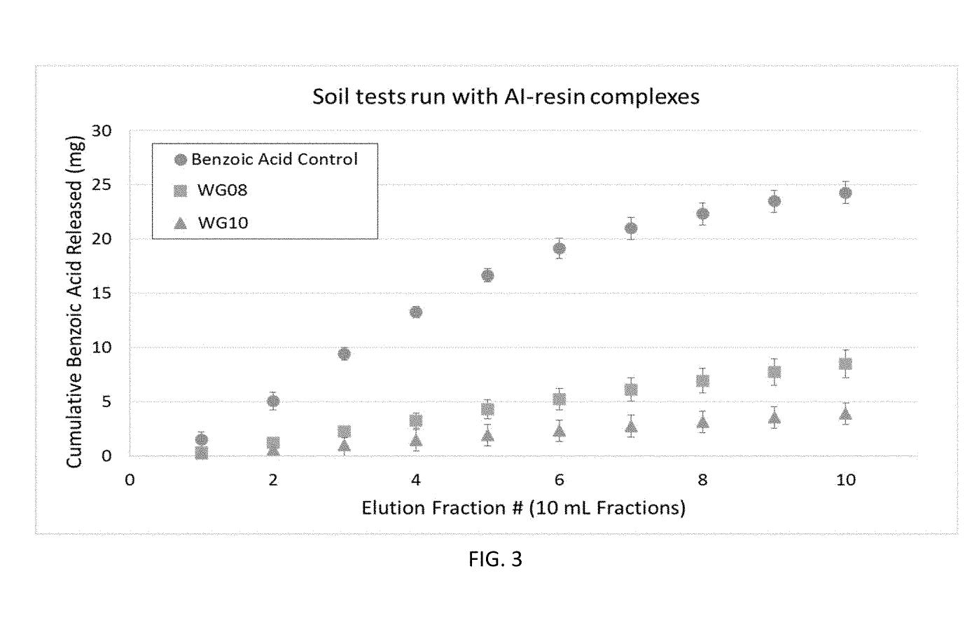

TABLE 18
(References samples whose release profiles are shown in FIG. 3)

| | Total AAI Released | Percent |
|---|---|---|
| Sample Name | (mg) | Release |
| Benzoic Acid | 24 | 97% |
| Control | | |
| WG08 | 8 | 34% |
| WG10 | 4 | 16% |

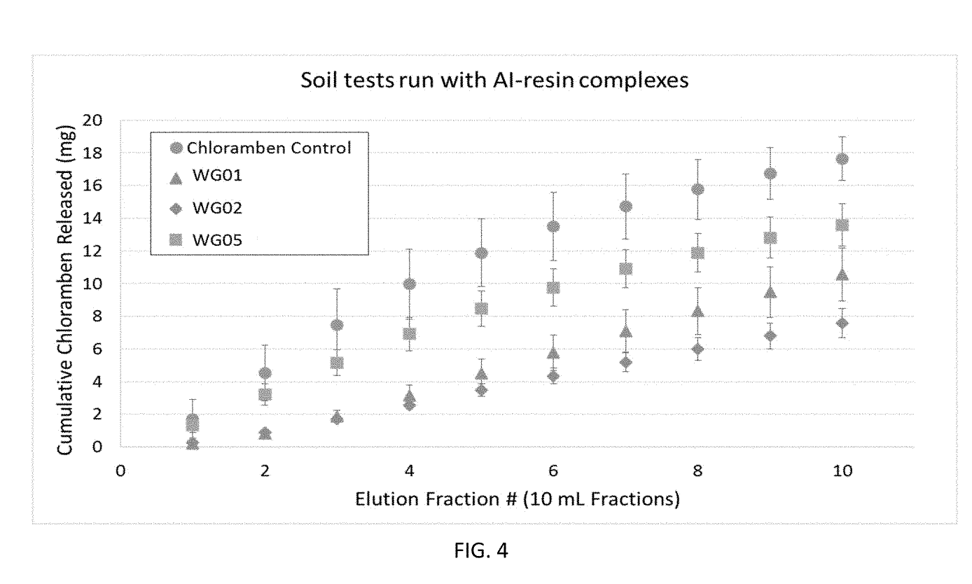

TABLE 19
(References samples whose release profiles are shown in FIG. 4)

| | Total AAI Released | Percent |
|---|---|---|
| Sample Name | (mg) | Release |
| Chloramben | 18 | 71% |
| Control | | |
| WG01 | 11 | 42% |
| WG02 | 8 | 30% |
| WG05 | 14 | 54% |

The formulated AAIs released slower than their respective controls (FIGS. 2-4). The powdered resins are more highly functionalized on the outside and less porous than the DOWEX 1×2 and 1×8 resins. Therefore, these resinates released more quickly than those prepared with the larger, more porous resins (FIGS. 2 and 4). The soil test results revealed a decrease in AAI release upon coating (FIGS. 2 and 3).

The results depicted in FIG. 4 correspond well with the sand column results shown in FIG. 1. The more highly crosslinked the resin, the slower the AAIs release (e.g., WG02 release profile compared with that of WG01).

### Example 16

### Formulation of WG06 as a HSC (HSC03)

A HSC has been formulated containing the IER-AAI complex. This HSC has proven stable upon dilution.

TABLE 20

| Materials | Amounts (g) |
|---|---|
| WG06 (from Example 12) | 40 |
| Tween 80 | 10 |
| Pluronic L64 | 15 |
| Aerosil 380 | 2 |
| BYK-7420 | 3 |
| Water | 70 |

The materials listed in Table 20 were used to prepare the HSC. First, the Tween 80 and Pluronic L64 were weighed out into an appropriately sized Nalgene bottle. Next the water and a stir bar were added. The surfactant was allowed to stir on a stir plate. Once the surfactant was incorporated, the BYK was added to the Nalgene bottle and stirred for two hours until it appeared to have been homogenously incorporated. The DOWEX 1×8 resins were then added and the bottle was shaken to mix. This combination was stirred until all the DOWEX 1×8 resins were wetted (about 30 minutes), creating a suspension. Finally, the silica was weighed out into a weigh boat and slowly added to the suspension while stirring. This was allowed to stir overnight until all the silica was wetted.

Next, the HSC was diluted 1:2, 1:4, and 1:7 to assess stability. To quantitatively assess stability of the HSC upon dilution, the separation index (SI) of each dilution was calculated. To calculate the separation index the following formula was used:

$$Separation Index ( SI ) = \frac{Height of Suspension ⋆}{Total Height of Liquid}$$

*The Height of Suspension value excludes any separated water at the top. The values for the separation index will be found between 0-1.

TABLE 21

| | | | SI after 5 | SI after |
|---|---|---|---|---|
| Dilution ratio | HSC Sample | Diluent | hours | 25 hours |
| 1:2 | 1 g HSC03 | 1 g tap water | 1 | 1 |
| 1:4 | 1 g HSC03 | 3 g tap water | 1 | 0.96 |
| 1:7 | 1 g HSC03 | 6 g tap water | 1 | 0.98 |

The HSC formulation subjected to the dilutions presented in Table 21. Upon dilution, the formulation remained stable for a reasonable window of time (>24 hrs); this stability can allow time for a farmer, for example, to uniformly spray his fields.

### Example 17

### HSC Formulation WG06 Formulated to Contain Additional AAI (HSC04)

One of the problems faced in the formulation of the IER-AAI complex into a HSC is the potential for a reduction in loading if ion exchange were to take place with e.g., the BYK-7420 liquid rheology additive which contains chloride ions. To circumvent this issue, and to generally improve overall loading, we dissolved excess salt of the AAI into the aqueous phase of the suspension.

TABLE 22

| Materials | Amounts (g) |
|---|---|
| WG06 (from Example 12) | 40 |
| Tween 80 | 10 |
| Pluronic L64 | 15 |
| Aerosil 380 | 2 |
| BYK-7420 | 3 |
| Water | 70 |
| Sodium benzoate (source of additional AAI) | 12 |

The materials listed in Table 22 were used to prepare the HSC. The experimental protocol followed the same procedure described in Example 16. The additional sodium benzoate was stirred (2 minutes) into the formulation after adding the surfactant and BYK and before wetting the IER.

### Example 18

### Conducting Soil Tests to Determine in-Vivo Release Profile of HSC

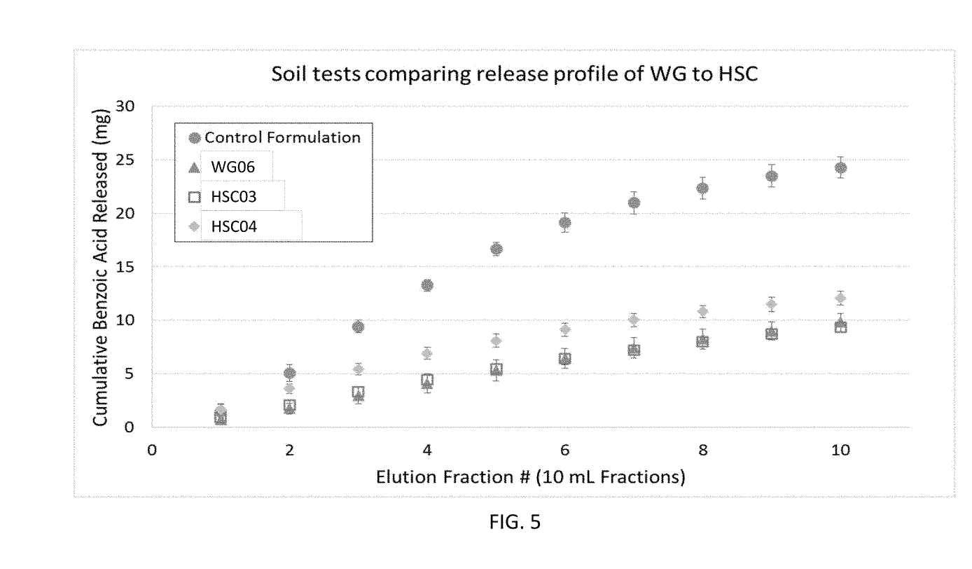

Soil tests (according to Example 15) were run to prove that the HSC03 maintained the extended release profile of the dry IER-AAI complex (WG06). Soil tests were also performed on the HSC04 to demonstrate that the addition of AAI-salt to the formulation would allow for an improved loading, without appreciably altering the extended release profile resinate. The results for this Example are depicted in FIG. 5 and tabulated in Table 23.

TABLE 23

| Sample | Total AAI | Percent | | Total Amount |
|---|---|---|---|---|
| Name | Released (mg) | Release | % Weight AAI | AAI (mg) |
| Control | 24 | 97% | 100% | 25 |
| Formulation | | | | |
| WG06 | 10 | 39% | 30% | 25 |
| HSC03 | 9 | 37% | 8.6% | 25 |
| HSC04 | 12 | 48% | 17% | 25 |

The soil tests confirm that HSC03 performs substantially identically to WG06, with the slight difference between them being statistically insignificant. The HSC04 has double the loading of HSC03 and yet only releases the AAI ˜10% faster. These results demonstrate that including additional AAI in the aqueous phase of the suspension encourages more AAI to imbibe.

### Example 19

### Demonstrating Controlled Release of Generic AAIs

Samples of various AAIs across the pesticide spectrum (having different water solubility and character) were obtained and imbibed into the DOWEX 1×8 resins according to Example 3. The following AAIs were tested:

TABLE 24

| AAI Genus | Representative Compounds |
|---|---|
| Herbicide | Dicamba |
| | Nicosulfuron (NSN) |
| Insecticide | Imidacloprid (ICD) |
| Plant Growth Regulator | Gibberellic Acid (GA) |

The imbibition was performed using the following set of materials for each AAI, where the AAI (as set forth in Table 24) used is a Representative Compound:

TABLE 25

| Materials | Amounts |
|---|---|
| Water (used for Dicamba and GA) | 35 mL |
| Acetone (used for NSN and ICD) | |
| DOWEX 1x8 IER | 1 g |
| AAI (from Table 24) | 1 g |

The amount of AAI was weighed out into a 40 mL glass vial and the water or acetone (AAI dependent) was added. Next, the IER was added and the cap of the vial was sealed with electrical tape and put on the shaker overnight. Each imbibition was filtered and washed with 40 mL of water followed by 40 mL of acetone. The washed resinates were placed into a FlackTek cup and stored in a vacuum oven overnight.

The percent loading and release profile for each AAI was obtained based on the protocols described in Examples 14 and 15 respectively, except that the AAI content was held constant at 20 mg instead of 25 mg.

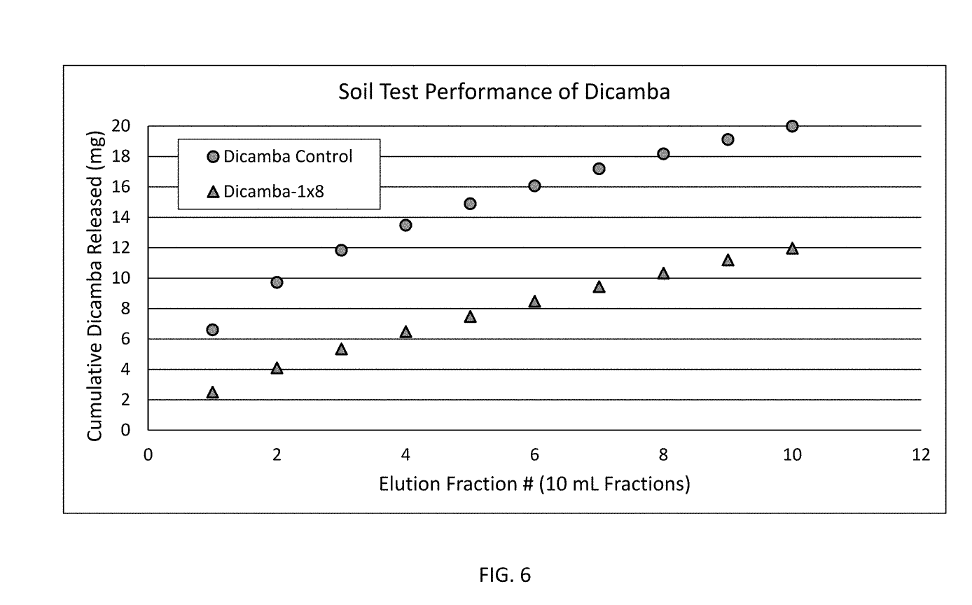

It should also be noted that the % loading was obtained using a phosphate solution instead of 2M NaOH, since some agricultural AAIs are prone to degradation under such harsh basic conditions. The release profiles of the resinates and their respective controls are plotted in FIGS. 6-9. The total release of AAI obtained from the soil tests is summarized in Tables 26-29.

TABLE 26
Dicamba (Elution fractions shown in FIG. 6)

| | Total AAI | Percent | % Weight | Total Amount |
|---|---|---|---|---|
| Sample Name | Released (mg) | Release | AAI | AAI (mg) |
| Dicamba | 20 | 100% | 100% | 20 |
| Control | | | | |
| Dicamba-1x8 | 12 | 59% | 48% | 20 |
| resinate | | | | |

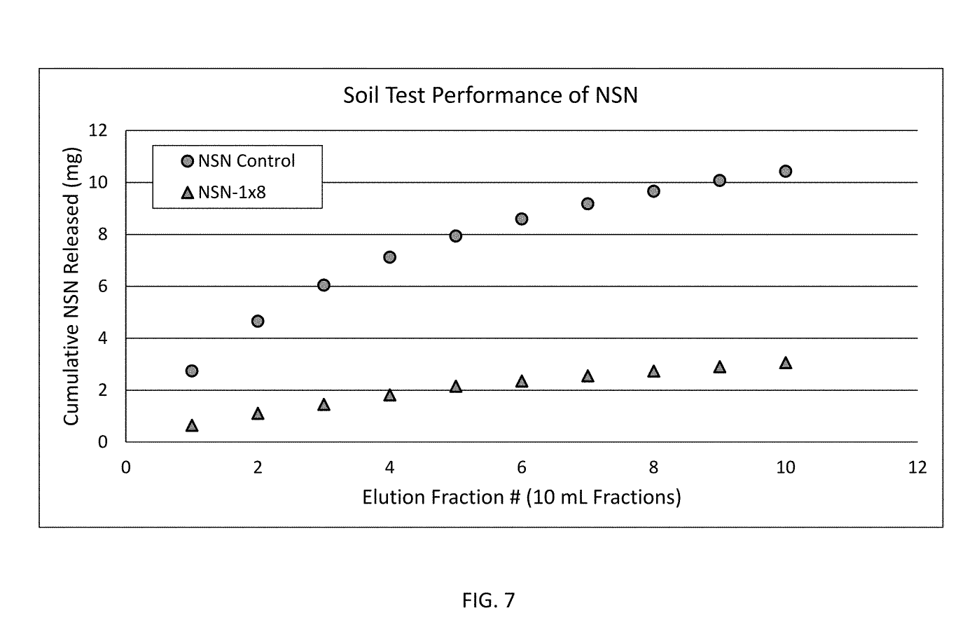

TABLE 27
Nicosulfuron (NSN) (Elution fractions shown in FIG. 7)

| Sample | Total AAI | Percent | % Weight | Total Amount AAI |
|---|---|---|---|---|
| Name | Released (mg) | Release | AAI | (mg) |
| NSN Control | 10 | 52% | 100% | 20 |
| NSN-1x8 | 3 | 15% | 42% | 20 |
| resinate | | | | |

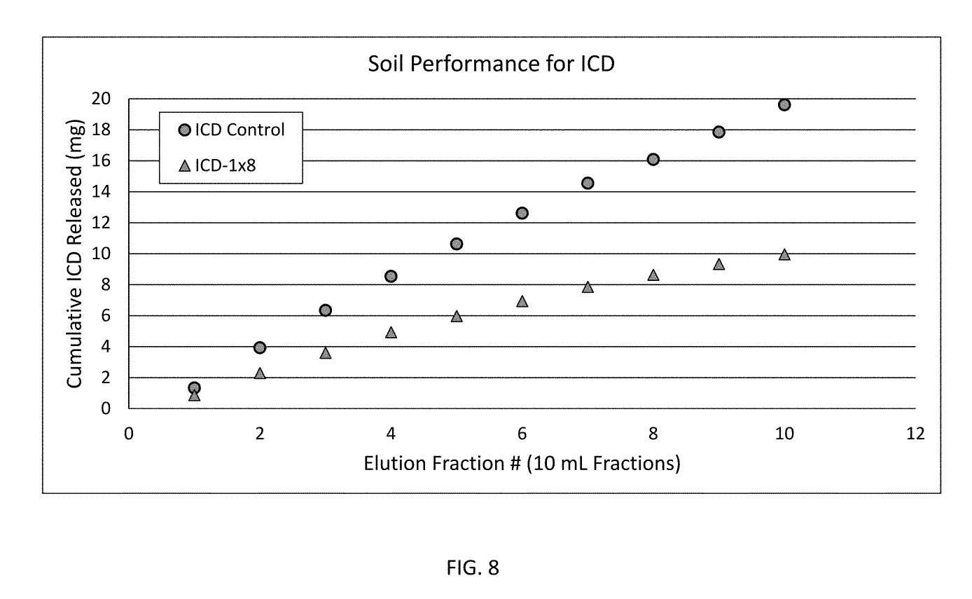

TABLE 28
Imidacloprid (ICD) (Elution fractions shown in FIG. 8)

| Sample | Total AAI | Percent | % Weight | Total Amount AAI |
|---|---|---|---|---|
| Name | Released (mg) | Release | AAI | (mg) |
| ICD Control | 20 | 98% | 100% | 20 |
| ICD-1x8 | 10 | 50% | 34% | 20 |
| resinate | | | | |

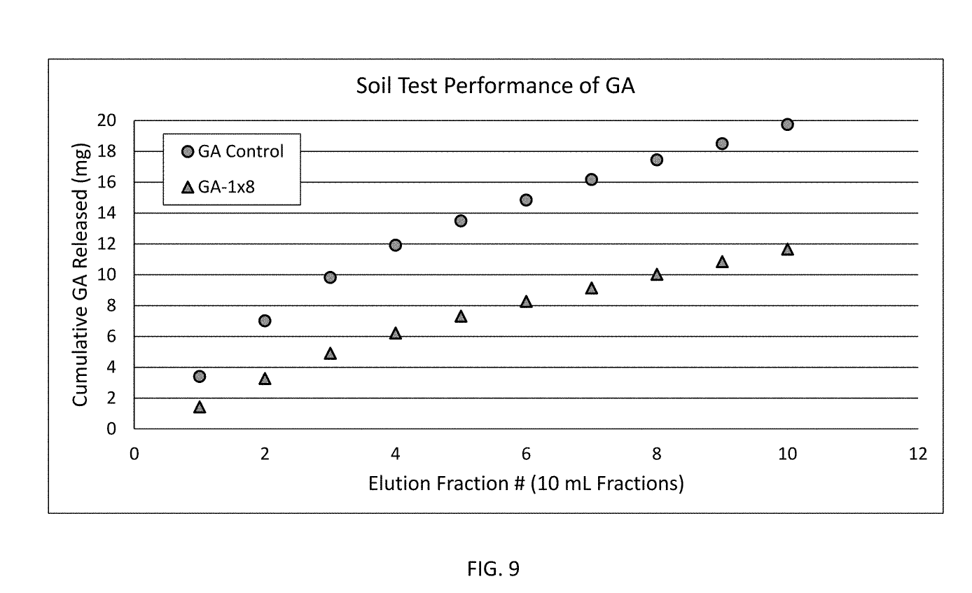

TABLE 29
Gibberellic Acid (GA) (Elution fractions shown in FIG. 9)

| | Total AAI | Percent | % Weight | Total Amount |
|---|---|---|---|---|
| Sample Name | Released (mg) | Release | AAI | AAI (mg) |
| GA Control | 20 | 99% | 100% | 20 |
| GA-1x8 resinate | 12 | 58% | 33% | 20 |

All four generic AAIs showed controlled release when prepared into resinates over their respective controls.

### Example 20

### Varying Imbibition Approaches

An appropriate amount (See Table 30) of DOWEX 1×8 IER was prepared according to the procedure described in Example 2. Two different imbibition approaches (column vs. jar) were pursued to determine if one was more effective at achieving a higher % loading than the other. Sodium benzoate (NaB), which is the salt version of benzoic acid, was used as the AAI model compound.

### Example 21

### “Continuous” Column Technique

Using the materials set forth in Table 30, a continuous phase column approach to preparing a resinate was performed.

TABLE 30

| Column Imbibition 1 | Column Imbibition 2 |
|---|---|
| 5 g DOWEX 1x8 resin | 5 g DOWEX 1x8 resin |
| 80 mL of 2M NaB in water | 80 mL of 1M NaB in water |
| 50 mL DI water | 50 mL DI water |
| 50 mL of Acetone | 50 mL of Acetone |

The purified resin/water solution was poured into a Chemglass chromatography column with a fritted disk. The IER-packed column was washed with a 1M and 2M solution of NaB. The residual NaB solution was cycled over the column multiple times to achieve optimal high % loading. The imbibed resin was next washed with water and finally with acetone to promote faster drying in the vacuum oven.

### Example 22

### “Static” Jar Technique

An adaptation of the process described in preparing a resinate in Example 3 was employed here using the materials listed in Table 31.

TABLE 31

| 1:1 Jar Imbibition1 | 2:1 Jar Imbibition1 |
|---|---|
| 10 g DOWEX 1x8 | 10 g DOWEX 1x8 |
| 10 g NaB | 20 g NaB |
| 100 mL DI Water | 100 mL DI water |

A 1:1 and 2:1 ratio of AAI:IER imbibition mixture was prepared using the above listed materials. The slurry was placed on a shaker overnight to allow for adequate time for imbibition of the AAI to take place. The resinate was recovered via vacuum filtration and washed with water, followed by acetone. Half of the recovered resinate was placed in a vacuum oven to dry overnight, while the other half was re-imbibed using the materials described in Table 32.

TABLE 32

| 1:1 Jar Imbibition 2 | 2:1 Jar Imbibition 2 |
|---|---|
| 5 g DOWEX 1x8 | 5 g DOWEX 1x8 |
| 5 g NaB | 10 g NaB |
| 50 mL DI Water | 50 mL DI water |

### Example 23

### Determining AAI Loading of the Imbibition Approaches

The protocol described in Example 14 was employed here to determine the % loading of the various imbibition approaches. The results are summarized in Table 33.

TABLE 33

| Imbibition Technique | % Loading |
|---|---|
| Column 1 | 29 |
| Column 2 | 31 |
| 1:1 Jar Imbibition 1 | 26 |
| 2:1 Jar Imbibition 1 | 25 |
| 1:1 Jar Imbibition 2 | 29 |
| 2:1 Jar Imbibition 2 | 29 |

The maximum % loading that may be achieved is dictated by a combination of the ion exchange capacity of the given resin, and the affinity of the AAI to the resin both via passive and ionic interactions. Both of the above mentioned imbibition techniques achieve the highest loading efficiency of the NaB, which appears to be ˜30%.

### Example 24

### Herbicide Volatility

For this Example, a known quantity (described below) of Dicamba-1×8 resinate from Example 19 was heated to 50° C. in a circulating oven. 2.4647 g of Dicamba-1×8 resinate was weighed into a weigh boat using an analytical balance. The resinate was placed into the oven at 50° C. and its weight was monitored at specific time intervals over a 1 week period. The amount of resinate that remained after 1 week was 2.4617 g. This correlates to loss of AI that was calculated to be 0.12%.

### Equivalents

While specific embodiments of the subject invention have been disclosed herein, the above specification is illustrative and not restrictive. While this invention has been particularly shown and described with references to preferred embodiments thereof, it will be understood by those skilled in the art that various changes in form and details may be made therein without departing from the scope of the invention encompassed by the appended claims. Many variations of the invention will become apparent to those of skilled art upon review of this specification. Unless otherwise indicated, all numbers expressing reaction conditions, quantities of ingredients, and so forth, as used in this specification and the claims are to be understood as being modified in all instances by the term “about.” Accordingly, unless indicated to the contrary, the numerical parameters set forth herein are approximations that can vary depending upon the desired properties sought to be obtained by the present invention.

1. A resinate formulation comprising an agricultural active ingredient and an ion exchange resin, wherein the agricultural active ingredient is imbibed upon the ion exchange resin.

2. The formulation of claim 1, wherein the formulation comprises a biodegradable ion exchange resin.

3. The formulation of claim 1, wherein the agricultural active ingredient is an anionic active ingredient or a cationic active ingredient.

4. (canceled)

5. (canceled)

6. The formulation of claim 1, wherein the agricultural active ingredient is a pesticide or a herbicide.

7. (canceled)

8. The formulation of claim 1, wherein the ion exchange resin is an anion exchange resin.

9. The formulation of claim 1, wherein the ion exchange resin is crosslinked.

10. The formulation of claim 1, wherein the ion exchange resin comprises a synthetic polymer or a modified naturally derived polymer.

11. The formulation of claim 10, wherein the synthetic polymer is a crosslinked styrene/divinyl benzene with an ionic comonomer.

12. The formulation of claim 10, wherein the modified naturally derived polymer is diethylamino ethylcellulose or carboxymethyl cellulose.

13. The formulation of claim 1, wherein the ion exchange resin comprises non-polymeric particles modified with organic ionic polymers.

14. The formulation of claim 1, wherein the resinate formulation is formulated as particles having a particle size distribution in the range of about 0.05 microns to about 5 mm based on median particle diameter.

15. The formulation of claim 13, wherein the particle size distribution is in the range of about 1 to about 200 microns based on median particle diameter.

16. The formulation of claim 1, wherein the formulation contains from about 1% to about 99% by weight of the agricultural active ingredient.

17-19. (canceled)

20. The formulation of claim 1, further comprising a coating.

21. The formulation of claim 20, wherein the coating comprises a drying oil blend.

22-24. (canceled)

25. A method of manufacturing an agricultural formulation comprising a resinate, comprising:
providing an agricultural active ingredient and an ion exchange resin; and
mixing the agricultural active ingredient and the ion exchange resin to imbibe the agricultural active ingredient upon the ion exchange resin, thereby forming the resinate.

26. The method of claim 25, wherein the step of mixing includes imbibing by passive imbibition.

27. (canceled)

28. The method of claim 25, further comprising coating the resinate.

29. (canceled)

30. (canceled)

31. The method of claim 28, wherein the step of coating comprises adding a drying oil blend to a surface of the resinate.

32. (canceled)

33. A method of treating an agricultural surface, comprising:
preparing the formulation of claim 1 containing an amount of an agricultural active ingredient sufficient for treating the agricultural surface;
formulating the formulation as a dispersible material, wherein the dispersible material comprises either water-dispersible particles or an aqueous suspension of particles;
dispersing the dispersible material in an aqueous vehicle to form a dispensable solution, wherein the dispensable solution contains the amount of the agricultural active ingredient sufficient for treating the agricultural surface; and
delivering the dispensable solution to the agricultural surface, thereby treating it.

34-36. (canceled)
